(19) United States
(12) Patent Application Publication
(10) Pub. No.: US 2002/0108821 A1
(43) Pub. Date: Aug. 15, 2002

(54) Lining devices for a disk brake and a method of making same

(75) Inventor: Andreas Munzert, Markgroningen (DE)

Correspondence Address: Crowell & Moring, L.L.P., Intellectual Property Group, P.O. Box 14300, Washington, DC, 20044-4300, US

(73) Assignee: Dr. Ing. h.c.F. Porsche AG

(21) Appl. No.: 10/071,195

(22) Filed: Feb. 11, 2002

(30) Foreign Application Priority Data
Feb. 10, 2001 (DE) DE 101 06 175.7

(51) Int. Cl. F16D 65/00

(52) U.S. Cl. 188/73.2

(57) ABSTRACT

Lining devices are provided for a disk brake having a brake disk, in which case the disk brake is suitable for the installation into a motor vehicle The brake disk comprises concave brake disk surfaces which interact with convex lining surfaces of the lining devices. Each lining device has a lining body with a convex lining surface and a lining support constructed in the manner of a plate, which lining support has a supporting surface for the lining body and a rear side, to which a piston of a caliber housing is guided, which caliper housing extends with a housing wall at a relatively small distance with respect to the rear side of the lining support. In order to achieve favorable space conditions, the lining device having the lining body, for the installation, is guided from a premounting position into a final installed position by way of the convex lining surface along the concave brake disk surface, the rear side of the lining support provided with the supporting surface being moved past the housing wall of the caliper housing receiving the piston at a defined distance.

### BACKGROUND AND SUMMARY OF THE INVENTION

This application claims the priority of German Patent Document DE 101 06 175.7, filed on Feb. 10, 2001, the disclosure of which is expressly incorporated by reference herein.

The invention relates to lining devices for a disk brake having a brake disk, preferably for a motor vehicle, which has concave brake disk surfaces which interact with convex lining surfaces of the lining device, said lining device having a lining body with at least one of said convex lining surfaces comprising a lining support constructed as a plate, said lining support having a supporting surface for the lining body and a rear side, to which a piston of a caliper housing is guided, said caliper housing extending with a housing wall at a relatively small distance with respect to the rear side.

A known lining device, in British Patent Document GB 1 586 465, has a lining body which is held in position on a supporting surface of a lining support. The supporting surface as well as the lining surface of the lining body, which faces a brake disk surface, are constructed as planes.

In German Patent Document DE 198 37 166 A1, a disk brake is shown suitable for the installation in a motor vehicle, which disk brake has a brake disk which is provided with spaced concave brake disk surfaces. Convex lining surfaces of lining bodies interact with the concave brake disk surfaces, the lining bodies and the lining supports forming lining devices. Each lining body is connected with a flat supporting surface of the pertaining lining support. As a result of the concave brake disk surfaces and the convex lining surfaces, disturbing noises can clearly be reduced, for example, during coasting braking, at pedestrian crosswalks, at traffic lights. However, viewed in the axial direction of the brake disk, the convex lining surfaces require more space for installing or exchanging lining devices. In addition, the convex design of the brake disk surfaces reduces the wearing thickness of the lining bodies, which impairs the operating time or durability of the lining devices.

It is therefore an aspect of the invention to take such measures at the brake disk that conventional space conditions will suffice for mounting the lining devices. Here, it should also be ensured that, despite convex lining surfaces, the lining devices have an optimized durability.

According to certain preferred embodiments of the invention, this aspect is achieved wherein the lining device having a lining body for installation from a premounting position into a final installed position is guided with the convex lining surface along the concave brake disk surface, the rear side of the lining support provided with the supporting surface being moved past the housing wall of the caliper housing receiving the piston at a defined distance. Additional characteristics further developing the invention are contained in the preferred embodiment.

The principal advantages achieved by way of certain preferred embodiments of the invention are that the lining device, although it is provided with a convex lining surface, can be mounted in a simple manner, that is, without any special space requirement, which is achieved by guiding the lining surface along the concave brake disk surface. This is also promoted by the clearance at the caliper housing. The fact that the supporting surface and the rear side of the lining support follow the shape of the convex lining surface contributes to the optimization of the wearing thickness of the lining body with respect to its durability and stability. Finally, the lining support is an easily producible component.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a partially sectional, lateral view of a disk brake having a brake disk and a caliper with lining devices; and

FIG. 2 shows an enlarged detail X of FIG. 1.

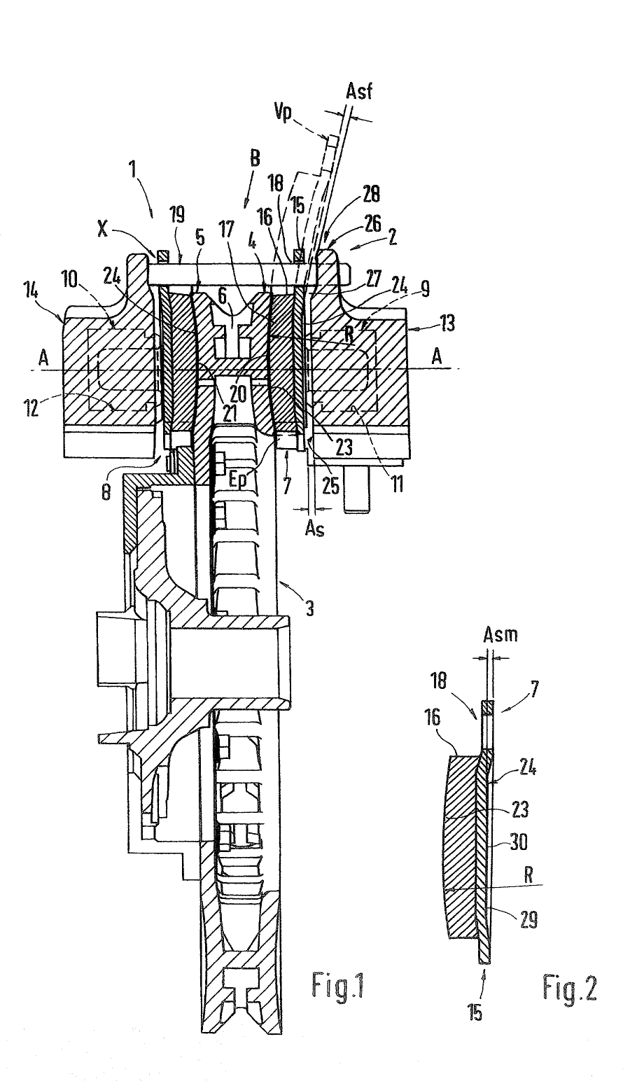

### DETAILED DESCRIPTION OF THE DRAWINGS

A disk brake 1, which may be installed, for example, in a road vehicle, a rail vehicle, an airplane or the like, comprises a caliper 2 and a brake disk 3 with opposite friction ring halves 4, 5 which bound a cooling duct 6.

The caliper 2 is constructed as a so-called fixed caliper which has lining devices 7, 8 floatingly disposed on both sides of the brake disk. The lining devices 7,8 can be acted upon by way of pistons 9, 10 which act in the axial direction A-A of the brake disk 3. The pistons 9, 10 are axially movably disposed in bores 11, 12 of caliper housings 13, 14. Each lining device, for example, 7, comprises a lining support 15 and a lining body 16 which are fixedly connected with one another on a supporting surface 17 of the lining support 15. The lining support 15 is provided with a bore 18 which surrounds a bolt 19 extending between the caliper housings 13, 14. The lining device 7 is displaceable on this bolt 19, specifically in its axial direction.

On the sides facing the lining devices 7, 8, that is, on the friction ring halves 4, 5, the brake disk 3 has concave brake disk surfaces 20, 21, the concavity of the brake disk surfaces 20, 21 being defined by a radius R. The lining devices 7, 8 are provided with lining surfaces 22, 23 which, having a convex construction, are determined by the radius R with respect to their shape and interact with the brake disk surfaces 20, 21. The convexity is also determined by the radius R.

The lining support 15 is constructed in the manner of a plate which extends in the radial direction of the brake disk 3 and, in addition to the supporting surface 17, has a rear side 24. The supporting surface 17 and the rear side 24 are arranged at a mutually parallel distance, the rear side 24 interacting with the piston 9 of the caliper housing 13. A housing wall 25 of the caliper housing 13 adjacent to the rear side 24 extends at a relatively narrow parallel distance As with respect to the rear side 24.

For the installation from a premounting position Vp into a final installed position Ep, the lining device 7 is guided with the convex lining surface 22 along the concave brake disk surface 20 in the peripheral direction B. In the process, the rear side 24 of the lining support 15 is moved without contact past the housing wall 25. The removal of the lining device 7 takes place in that the lining device 7 is guided in the opposite peripheral direction B. In an end region 26 adjacent to the bolt 19, from which the lining device 7 is installed, the housing wall 25 is provided with a recess-type clearance 27 which extends away from the abovementioned lining device and the rear side 24 of the lining support 15 respectively. As a result, the space Asf is formed between the rear side 24 and an adjacent end 28 of the end region 26 of the housing wall 24 and of the clearance 27 respectively.

The supporting surface 17 and also the rear side 24 of the lining support 15 follow at least approximately and in sections the convex shape of the lining surface 23 of the lining body 16—FIG. 2—, which contributes to optimizing the wearing thickness of the latter. For this purpose, the lining support 15 is provided with a penetration 29—FIG. 2—of the distance measurement Asm, in which case the rear side 24 can be constructed as a plane 30 at least in the region of the piston 9.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lining device for a disk brake having a brake disk with concave brake disk surfaces which interact with convex lining surfaces of the lining device, said lining device having a lining body with at least one of said convex lining surfaces, comprising:
a lining support constructed as a plate, said lining support having a supporting surface for the lining body and a rear side, to which a piston of a caliper housing is operatively guided, said caliper housing extending with a housing wall at a relatively small distance with respect to the rear side,
wherein the lining device having the lining body for installation from a premounting position into a final installed position is guided with the convex lining surface along the concave brake disk surface, the rear side of the lining support provided with the supporting surface being moved past the housing wall of the caliper housing receiving the piston at a defined distance.

2. Lining device according to claim 1, wherein the housing wall of the caliper housing has, in an end region from which the lining device is installed, a clearance leading away from the rear side of the lining device.

3. Lining device according to claim 1, wherein the supporting surface, at least in sections, in a region of the lining body, approximately follows the shape of the convex lining surface.

4. Lining device according to claim 3, wherein the rear side, at least in sections, in a region of the lining body, approximately follows the shape of the convex lining surface.

5. Lining device according to claim 1, wherein at least the rear side of the lining support is constructed as a plane in a region of the piston.

6. Lining device according to claim 2, wherein at least the rear side of the lining support is constructed as a plane in a region of the piston.

7. Lining device according to claim 3, wherein at least the rear side of the lining support is constructed as a plane in a region of the piston.

8. Lining device according to claim 1, wherein the supporting surface and the rear side of the lining support extend at least in sections at a substantially identical distance with respect to one another.

9. Lining device according to claim 2, wherein the supporting surface and the rear side of the lining support extend at least in sections at a substantially identical distance with respect to one another.

10. Lining device according to claim 3, wherein the supporting surface and the rear side of the lining support extend at least in sections at a substantially identical distance with respect to one another.

11. Lining device according to claim 5, wherein the supporting surface and the rear side of the lining support extend at least in sections at a substantially identical distance with respect to one another.

12. A disk brake, comprising:
lining devices, each of the lining devices having a lining body with a respective convex surface,
a brake disk with concave surfaces which interact with the convex surfaces of the lining devices,
at least one lining support constructed as a plate having a supporting surface for the lining body and a rear side, and
at least one caliper housing extending with a housing wall at a distance from the rear side, a piston of the caliper housing being guided to the rear side in use,
wherein at least one of the lining devices for installation into an installed position is guided with the convex surface along one of the concave surfaces, whereby the rear side is moved past the housing wall at a defined distance.

13. A method of making a disk brake, comprising;
providing a brake disk with concave surfaces which operatively interact with convex surfaces of lining devices, said lining devices having a respective lining body with the convex surfaces,
constructing a lining support as a plate, the lining support having a supporting surface for the lining body and a rear side, to which a piston of a caliper housing is operatively guided, and
guiding one of the lining devices for installation from a premounting position into a final installed position with the convex surface along the respective concave surface whereby the rear side is moved past a housing wall of the caliper housing at a defined distance,
wherein the caliper housing extends with the housing wall at a relatively small distance with respect to the rear side.
